(19) United States
(12) Patent Application Publication
(10) Pub. No.: US 2018/0094719 A1
(43) Pub. Date: Apr. 5, 2018

(54) A Shifter Assembly For Selecting One Of A Plurality Of Gears Of A Transmission For A Vehicle And A Method For Selecting The Same

(71) Applicant: Kongsberg Driveline Systems I, Inc., Novi, MI (US)

(72) Inventor: Terrentha Hill, Redford, MI (US)

(21) Appl. No.: 15/553,800

(22) PCT Filed: Feb. 27, 2015
(86) PCT No.: PCT/US2015/018025

§ 371 Date: Aug. 25, 2017

(51) Int. Cl. F16H 59/02; F16H 59/04; F16H 59/10; F16H 61/24

(52) U.S. Cl. CPC F16H 59/0204; F16H 59/044; F16H 59/105; F16H 2061/242; F16H 2059/0295; F16H 2059/0239; F16H 2059/0269; F16H 61/24

(57) ABSTRACT

A shifter assembly is used for selecting one of a plurality of gears of a transmission for a vehicle. The assembly includes a housing defining a shift pattern having first and second gates defining first and second shift positions, respectively. A lever is selectively movable into and out of the first and second shift positions within each of the first and second gates. A blocking system is transitionable between a first state which opens the first gate and closes at least a portion of the second gate and a second state which opens the second gate and closes at least a portion of the first gate. A knob is coupled to the lever and is rotatable between first and second positions and communicates with the blocking system to cause the transition of the blocking system between the first and second states when in the first and second positions, respectively.

### BACKGROUND OF THE INVENTION

### 1. Field of the Invention

The subject invention relates to a shifter assembly for selecting one of a plurality of gears of a transmission for a vehicle and a method of selecting one of the plurality of gears of the transmission for the vehicle using the shifter assembly.

### 2. Description of Related Art

There is a desire within the automotive industry to electronically control shifting of gears of a transmission of a vehicle. Many different shifter assemblies have been developed to be used in “shift-by-wire” systems. One of the most common shifter assemblies known are commonly referred to as a “gate shifter.” The gate shifter is commonly used to shift the transmission into a plurality of gears, such as Park, Reverse, Neutral, and Drive. The gate shifter is also commonly used to manually select the gears of the transmission in the drive position (commonly referred to as a “manumatic,” “tiptronic,” or “touchshift” gear selection).

Certain gate shifters have a monostable position, meaning a shift lever automatically returns to the monostable position after shift lever has been moved to a position for shifting the gears of the transmission. Although effective, gate shifters having the monostable position are susceptible to inadvertent movements due to accidental application of force, such as a driver or a passenger bumping the shift lever or longitudinal or lateral acceleration caused by sudden movements of the vehicle (commonly referred to as g-force). Inadvertent movements of the shift lever can cause accidental selection a gear that was not intended by the driver. As such, there remains a need to provide an improved shifter assembly.

### SUMMARY OF THE INVENTION AND ADVANTAGES

The subject invention provides a shifter assembly for selecting one of a plurality of gears of a transmission for a vehicle. The assembly includes a housing defining a shift pattern having a first gate defining at least one first shift position and a second gate defining at least one second shift position.

The shifter assembly further includes a lever extending through the shift pattern along an axis between a first end and a second end and coupled to the housing. The lever is selectively movable between the first and second gates and selectively movable into and out of the first and second shift positions within each of the first and second gates.

The shifter assembly further includes a blocking system mounted to the housing and transitionable between a first state and a second state with the blocking system opening the first gate to permit movement of the lever within the first gate to the first shift position and simultaneously closing at least a portion of the second gate to restrict movement of the lever into the second shift position when in the first state. The blocking system opens the second gate to permit movement of the lever within the second gate to the second shift position and simultaneously closes at least a portion of the first gate to restrict movement of the lever into the first shift position when in the second state.

The shifter assembly further includes a knob coupled to the second end of the lever and rotatable about the axis between a first position and a second position. The knob is in communication with the blocking system to cause the transition of the blocking system between the first state when in the first position and the second state when in the second position.

The subject invention also provides a method of selecting one of a plurality of gears of a transmission for a vehicle using a shifter assembly which includes a housing defining a shift pattern having a gate defining at least one shift position with a lever extending through the shift pattern. The shifter assembly further includes a blocking system mounted to the housing and a knob coupled to the lever and in communication with the blocking system.

The method includes the steps of rotating the shift knob from a first position to a second position, transitioning the blocking system from a first state to a second state, opening the gate with the blocking system, and moving the lever to the at least one shift position within the gate.

Accordingly, the blocking system prevents the inadvertent movement of the lever into one of the first and second shift positions by application of some force. Restricting the movement of the lever into one of the first and second shift positions prevents accidental miss-shifts which may damage the transmission. Furthermore, the rotation of the knob allows a user to quickly select which of the first and second shift positions the user would like to move the lever to, without the need to actuate a button or switch spaced from the shifter assembly.

### BRIEF DESCRIPTION OF THE DRAWINGS

Advantages of the subject invention will be readily appreciated as the same becomes better understood by reference to the following detailed description when considered in connection with the accompanying drawings.

FIG. 1 is a perspective view of a shifter assembly showing a housing defining a shift channel, a lever, and a knob.

FIG. 2 is a perspective view of the shifter assembly showing the lever, the knob, and a biasing mechanism.

FIG. 3 is an elevational view of shifter assembly with the lever in a rest position and disposed within a second gate of the shift channel.

FIG. 4 is perspective view of the lever and the knob showing a plurality of rotation sensors.

FIG. 5 is an elevational view of the shift assembly with the lever in an actuated position and disposed in one of three shift positions of a first gate of the shift channel.

FIG. 6 is an elevational view of the shift assembly with the lever in another actuated position and disposed in another one of three shift positions of the first gate of the shift channel.

FIG. 7 is an elevational view of the shift assembly with the lever in yet another actuated position and disposed in yet another one of three shift positions of the first gate of the shift channel.

FIG. 8 is an elevational view of the shift assembly with the lever in yet another actuated position and disposed in one of two shift positions of a second gate of the shift channel.

FIG. 9 is an elevational view of the shift assembly with the lever in yet another actuated position and disposed in another one of two shift positions of the second gate of the shift channel.

FIG. 10 is a perspective view of the shift assembly with the lever pivoting to an actuated position within the first gate.

FIG. 11 is a perspective view of the shift assembly with the lever pivoting to an actuated position within the second gate.

### DETAILED DESCRIPTION OF THE INVENTION

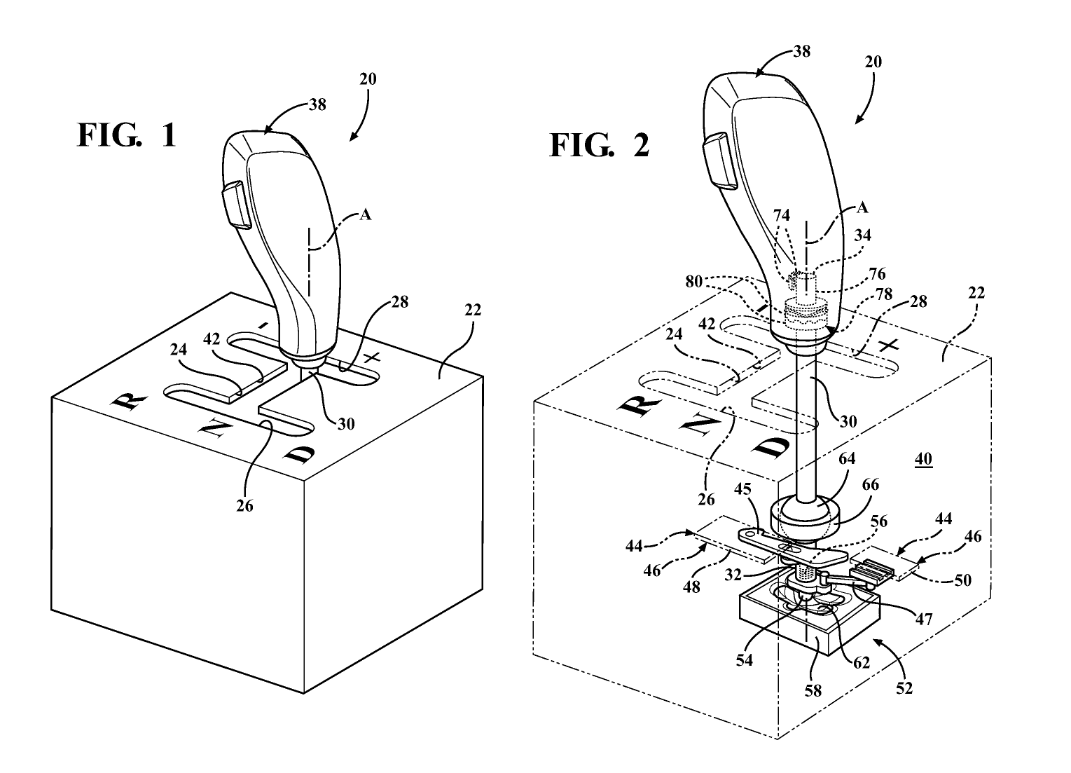

Referring to the Figures, wherein like numerals indicate like or corresponding parts throughout the several views, a shifter assembly 20 for selecting one of a plurality of gears of a transmission for a vehicle is generally shown in FIGS. 1 and 2. Generally, the shifter assembly 20 is used in shift-by-wire operation to electrically signal which of one of the plurality of gears of the transmission for the vehicle should be selected. However, it is to be appreciated that communication between the shifter apparatus 30 and the transmission can be through any suitable mechanical components, including but not limited to rods, pulleys, cables, and the like.

The shifter assembly 20 includes a housing 22 defining a shift pattern 24 having a first gate 26 defining at least one first shift position and a second gate 28 defining at least one second shift position. The shifter assembly 20 further includes a lever 30 extending through the shift pattern 24 along an axis A between a first end 32 and a second end 34 and coupled to the housing 22. The lever 30 is selectively movable between the first and second gates 26, 28 and selectively movable into and out of the first and second shift positions within each of the first and second gates 26, 28.

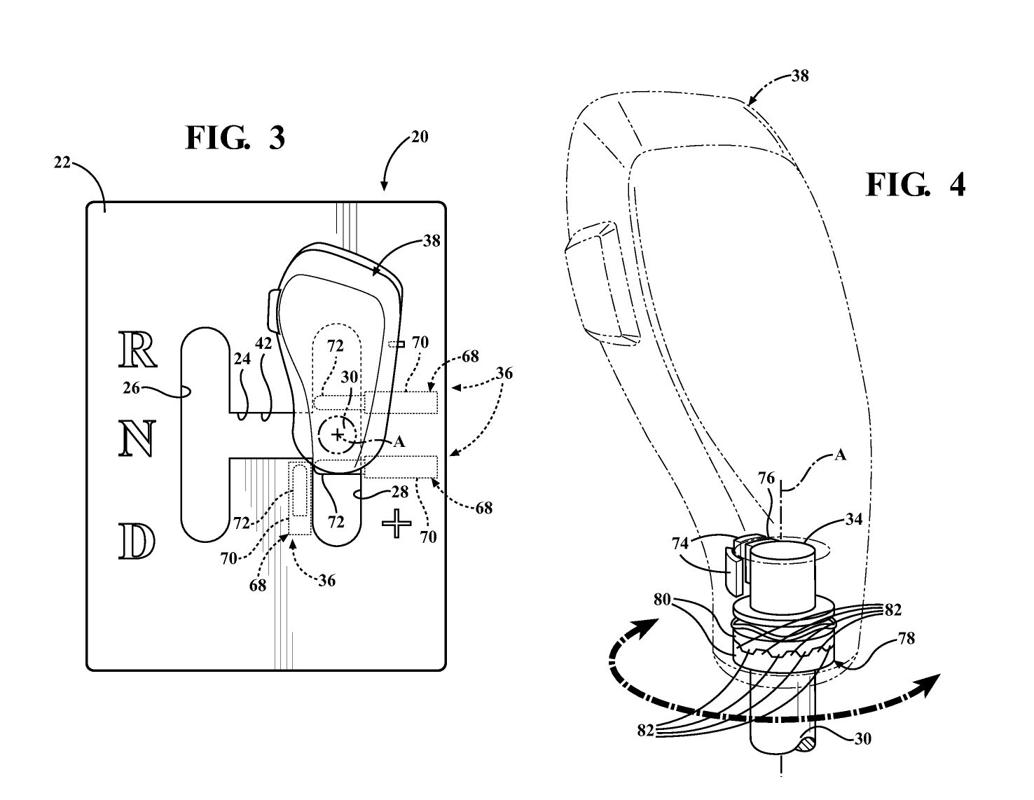

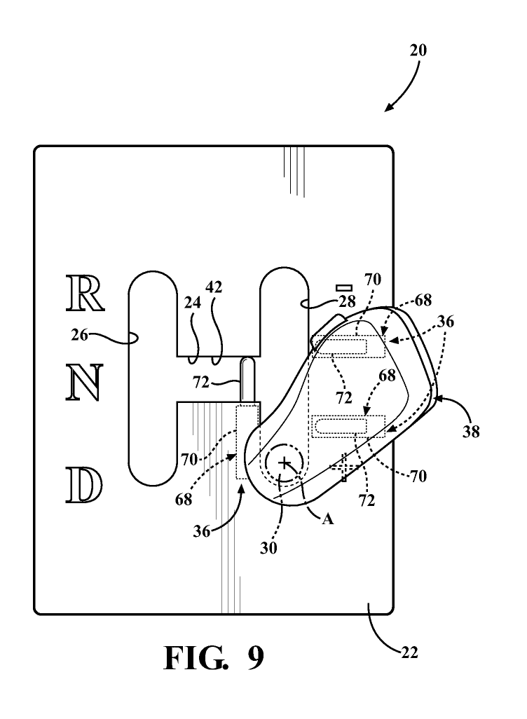

The shifter assembly 20 also includes a blocking system 36, shown in FIGS. 3 and 5-9, mounted to the housing 22 and transitionable between a first state and a second state. The blocking system 36 opens the first gate 26 to permit movement of the lever 30 within the first gate 26 to the first shift position and simultaneously closes at least a portion of the second gate 28 to restrict movement of the lever 30 into the second shift position when in the first state, as shown in FIGS. 3 and 5-7. The blocking system 36 opens the second gate 28 to permit movement of the lever 30 within the second gate 28 to the second shift position and simultaneously closes at least a portion of the first gate 26 to restrict movement of the lever 30 into the first shift position when in the second state, as shown in FIGS. 8 and 9.

The shifter assembly 20 further includes a knob 38 coupled to the second end 34 of the lever 30 and rotatable about the axis A between a first position (shown in FIGS. 3 and 5-7) and a second position (shown in FIGS. 8 and 9) with the knob 38 in communication with the blocking system 36 to cause the transition of the blocking system 36 between the first state when in the first position and the second state when in the second position.

As shown in the Figures, housing 22 is substantially cubical. This is for exemplary purposes. It is to be appreciated that the housing 22 may be any size, shape, and configuration. The housing 22 may define an interior 40 with the lever 30 extending through the shift pattern 24 along the axis A with the first end 32 disposed in the interior 40 of the housing 22 and the second end 34 disposed outside of the interior 40 of the housing 22.

As shown in FIGS. 1 and 2, the shift pattern 24 may have an intermediate gate 42 between the first and second gates 26, 28 with the intermediate gate 42 interconnecting the first and second gates 26, 28 to facilitate movement of the lever 30 between the first and second gates 26, 28 to each of the first and second shift positions. It is to be appreciated that the first and second gates 26, 28 may be directly interconnected. Said differently, the first and second gates 26, 28 may be transverse to one another such that the first and second gates 26, 28 interconnect.

As shown in FIG. 3, the first and second gates 26, 28 may be substantially parallel with the intermediate gate 42 transverse to each of the first and second gates 26, 28. More specifically, the intermediate gate 42 may be perpendicular to each of the first and second gates 26, 28. In such a configuration the shift pattern 24 resembles the letter “H”. It is to be appreciated that the intermediate gate 42 may interconnect the first and second gates 26, 28 at any angle.

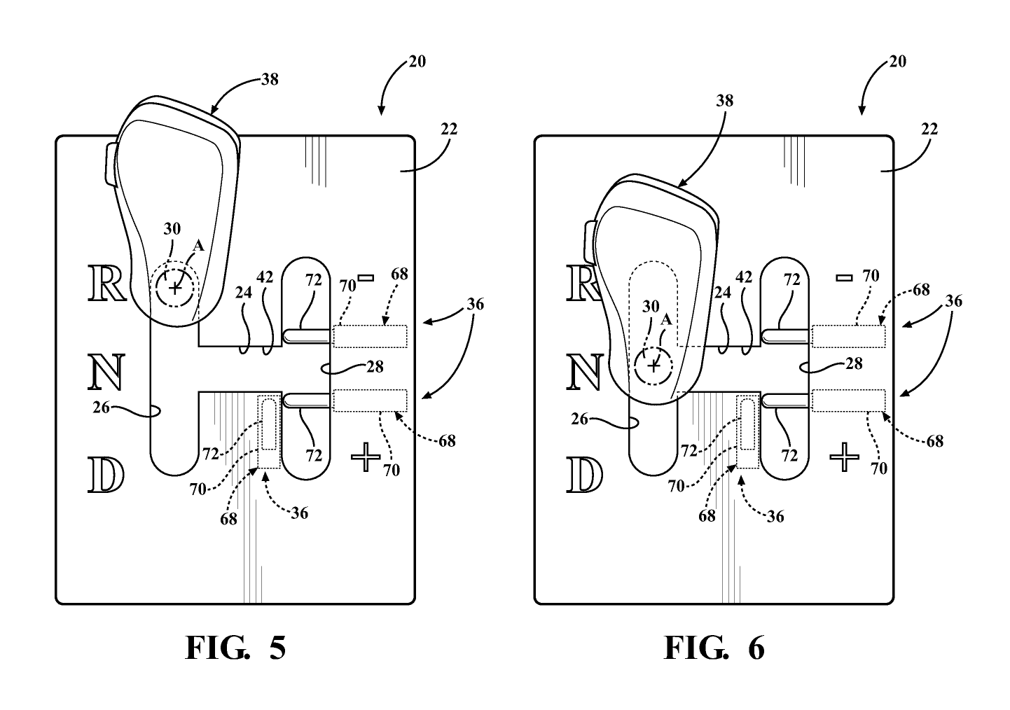

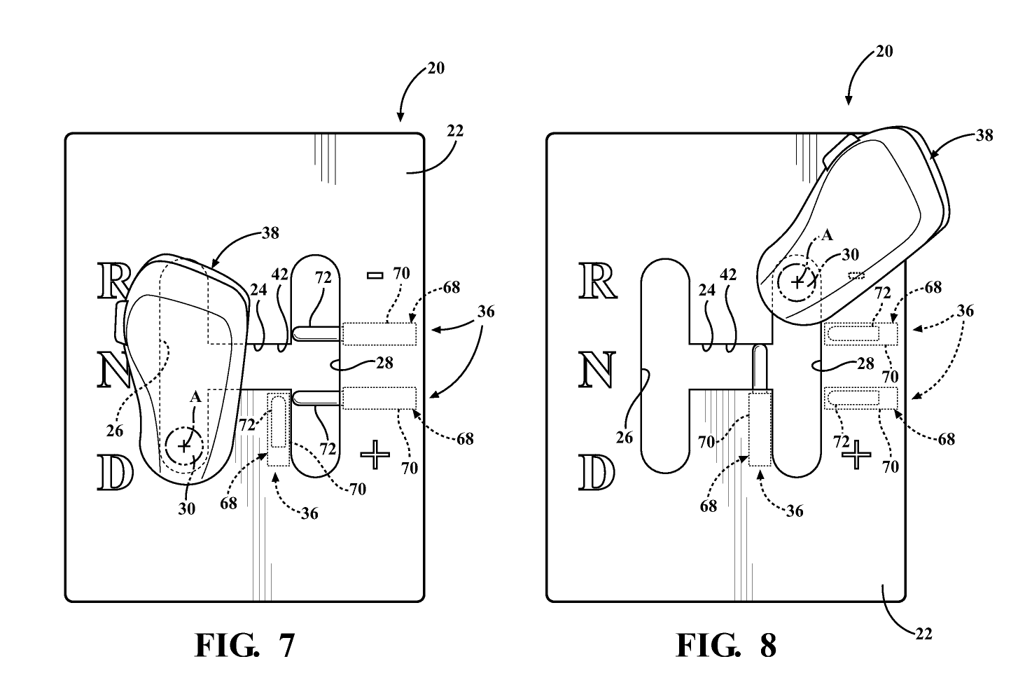

The at least one first shift position is further defined as three first shift positions and the at least one second shift position is further defined as two second shift positions. Usually, the three first shift positions are an “R” shift position which corresponds with engagement of a reverse gear of the transmission, an “N” shift position which corresponds with none of the gears of the transmission being engaged, and a “D” shift position which corresponds with engagement of one or more forward drive gears. FIG. 5 illustrates the lever 30 in the “R” shift position, FIG. 6 illustrates the lever 30 in the “N” shift position, and FIG. 7 illustrates the lever 30 in the “D” shift position. Usually, the two second shift positions are a “+” shift position which selects the next higher gear of the forward drive gears and a “−” shift position which selects the next lower gear of the forward drive gears. FIG. 9 illustrates the lever 30 in the “+” shift position and FIG. 8 illustrates the lever 30 in the “−” shift position. It is to be appreciated that the three first shift positions and the two second shift positions may correspond with any gears of the transmission. It is also to be appreciated that the first and second shift positions may be any number of shift positions.

As shown in FIGS. 2 and 10-11, the shifter assembly 20 may further include a first sensor 44 coupled to the housing 22 and associated with the first shift position to detect when the lever 30 is in one of the activated positions that corresponds with the first shift position, and a second sensor 46 coupled to the housing 22 and associated with the second shift position to detect when the lever 30 is in another of the activated positions that corresponds with the second shift position. The first and second sensors 44, 46 may be a plurality of sensors. For example, as described above the first shift position may be three first shift positions and the second shift position may be two second shift positions. In such a configuration, the first sensor 44 would be further defined as at least three first sensors 44 and the second sensor 46 would be further defined as at least two second sensors 46. Furthermore, each of the first and second sensors 44, 46 may individually be comprised of a plurality of sensors. For example, as shown FIGS. 2 and 10-11, the shifter assembly 20 may include a first arm 45 and a second arm 47 each coupled to and extending from the lever 30. The shifter assembly 20 may also include a first sensor plate 48 and a second sensor plate 50. The first arm 45 may be slidable along the first sensor plate 48 between a plurality of positions and the second arm 47 may be slidable along the second sensor plate 50 between a plurality of positions. The first and second shift positions each individually correspond to unique positions of the first and second arms 45, 47 relative to the first and second sensor plates 48, 50. Such a configuration is described in International Patent Application No. PCT/IB2014/064320 filed on Sep. 8, 2014 which claims priority to U.S. Provisional Patent Application No. 61/874,598 filed on Sep. 6, 2013, as well as International Patent Application No. PCT/IB2014/064322 filed on Sep. 8, 2014 which claims priority to U.S. Provisional Patent Application No. 61/874,598 filed on Sep. 6, 2013, each of which is incorporated here by reference.

The lever 30 may have a rest position and an activated position. The rest position refers the position to which the lever 30 the returns after the lever 30 has been moved, which will be further described below and is shown in FIG. 3. The activated position is any position that the lever 30 is moved to which is spaced from the rest position and is shown in FIGS. 5-9.

As shown in FIG. 3, the lever 30 may extend through the second gate 28 spaced from the second shift position of the second gate 28 when in the rest position. More specifically, the lever 30 may extend through second gate 28 spaced from each of the two second shift positions of the second gate 28 when in the rest position. It is to be appreciated that the lever 30 may extend through the first gate 26, the intermediate gate 42, or through any other portion of the shift pattern 24 in the rest position.

The activated position may be further defined as a plurality of activated positions with one of the activated positions corresponding to the first shift position and another one of the activated positions corresponding with the second shift position. More specifically, three of the activated positions individually correspond to each of the three first shift positions, as shown in FIGS. 5-7, and two of the activated positions individually correspond to each of the two second shift positions, as shown in FIGS. 8 and 9. The lever 30 is moved to the activated positions to engage the first and second shift positions. Said differently, the lever 30 does not engage the first and second shift positions in the rest position.

The shifter assembly 20 may further include a biasing mechanism 52, shown in FIG. 2, in communication with the lever 30 to continuously bias the lever 30 to the rest position. The biasing mechanism 52 may include a plunger 54 slidably disposed within the lever 30, a biasing member 56 abutting each of the lever 30 and the plunger 54 to continuously bias the plunger 54 away from the lever 30, and a detent track 58 disposed within and coupled to the housing 22 defining the rest position with the biasing member 56 biasing the plunger 54 into engagement with the detent track 58. More specifically, the lever 30 may define a bore along the axis A at the first end 32. Each of the biasing member 56 and the plunger 54 may be disposed within the bore with the plunger 54 at the first end 32 of the lever 30 and the biasing member 56 between the first and second ends 32, 34 of the lever 30. The biasing member 56 biases the plunger 54 along the axis A such that the plunger 54 extends out the bore at the first end 32.

The detent track 58 has a surface 62 which varies in height. The plunger 54 engages the surface 62 of the of the detent track 58. The greater the height of the surface 62, the farther the plunger 54 is disposed within the bore and the greater the bias exerted by the biasing member 56. As such, the lever 30 moves to where the plunger 54 engages a portion of the detent track 58 where the height of the surface 62 is the lowest and where the bias exerted by the biasing member 56 is the lowest. The portion of the detent track 58 where the height of the surface 62 is the lowest corresponds with the rest position of the lever 30 with any other portion of the detent track 58 where the height is greater than the lowest portion corresponds with the activated position. It is to be appreciated that the lever 30 may be biased to the rest position by any suitable configuration.

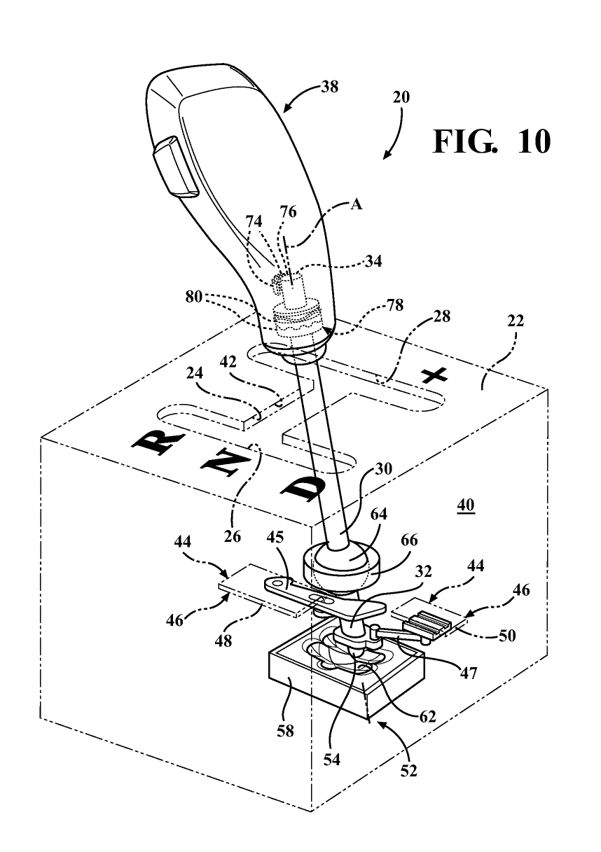

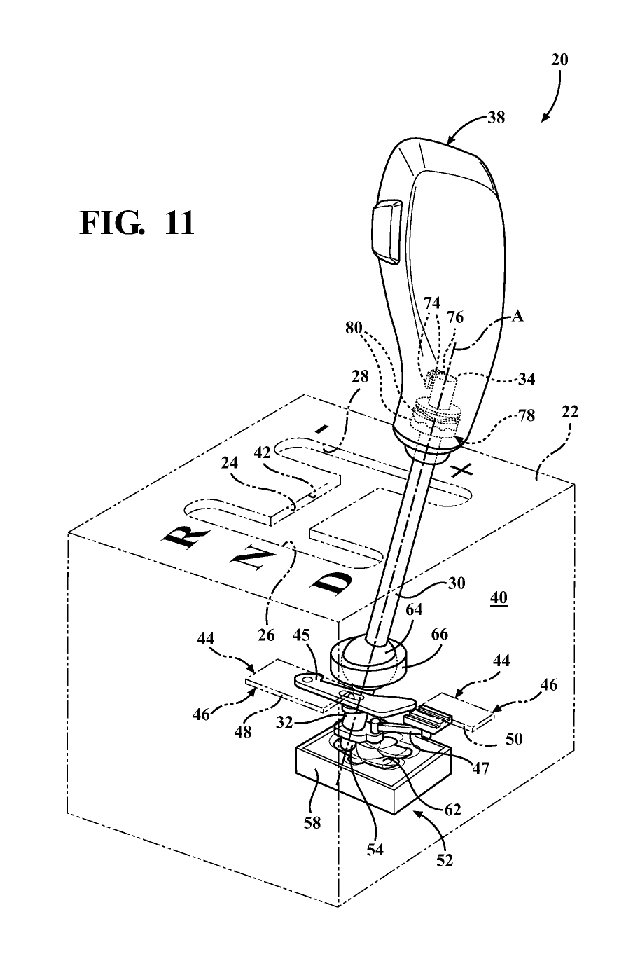

The lever 30 may be capable of pivoting relative to the housing 22 to selectively move the lever 30 between the rest position, shown in FIG. 2, and the activated positions, illustrated in part by FIGS. 10 and 11. For example, as shown in the FIGS. 2 and 10-11, the lever 30 and the housing 22 may have a “ball and socket” configuration with the lever 30 having a ball 64 and the housing 22 having a socket 66 which retains the ball 64. The lever 30 pivots at the ball 64. It is to be appreciated that the lever 30 may pivot relative the housing 22 using any suitable configuration, including, but not limited to, a gimbal configuration.

As shown in FIGS. 3 and 5-9, the blocking system 36 may be further defined as at least two blocking members 68. One of the at least two blocking members 68 may open the first gate 26 in the first state to permit movement of the lever 30 within the first gate 26 to the first shift position and may close at least a portion of the first gate 26 in the second state to restrict movement of the lever 30 into the first shift position. Another one of the at least two blocking members 68 may close at least a portion of the second gate 28 in the first state to restrict movement of the lever 30 into the second shift position and may open the second gate 28 in the second state to permit movement of the lever 30 within the second gate 28 to the second shift position.

As shown in the Figures, the at least two blocking members 68 may be three blocking members 68. With the lever 30 positioned in the second gate 28 in the rest position, one of the blocking members 68 is positioned adjacent to the intermediate gate 42 and opens (as shown in FIGS. 3 and 5-7) and closes (as shown in FIGS. 8 and 9) the intermediate gate 42 in the first state and the second state, respectively. The opening and closing of the intermediate gate 42 in-turn opens and closes the first gate 26. The other two blocking members 68 work together to open and close the second gate 28. One of the blocking members 68 is positioned adjacent to the second gate 28 and between the intermediate gate 42 and one of the two second shift positions. The other one of the blocking members 68 is positioned adjacent to the second gate 28 and between the intermediate gate 42 and the other one of the two second shift positions. In the first state shown in FIGS. 3 and 5-7, the two blocking members 68 close the second gate 28 such that the lever 30 may be within the second gate 28 but may not move to either of the two second shift positions. In the second state shown in FIGS. 8 and 9, the two blocking members 68 open the second gate 28 such that the lever 30 may move to either of the two second shift positions. It is to be appreciated that the blocking members 68 may be any number of blocking members 68 and in any configuration to selectively open and close the first and second gates 26, 28.

Each of the at least two blocking members 68 may include a solenoid 70 and a plunger 72 with the solenoid 70 capable of moving the plunger 72 for selectively closing the respective gate 26, 28. More specifically, the solenoid 70 and the plunger 72 may be aligned transverse to the respective gate 26, 28. The solenoid 70 moves the plunger 72 such that the plunger 72 extends across the gate 26, 28 and closes the gate 26, 28. The solenoid 70 also moves the plunger 72 such that the plunger 72 is spaced from the gate 26, 28 and thus opens the gate 26, 28. It is to be appreciated that the blocking members 68 may open and close the gates 26, 28 through any suitable manner and configuration.

The shifter assembly 20 may further include a plurality of rotation sensors 74 as shown in FIG. 4, with one of the rotation sensors 74 detecting when the knob 38 is in the first position to transition the blocking system 36 to the first state and another one of the rotation sensors 74 detecting when the knob 38 is in the second position to transition the blocking system 36 to the second state.

Usually, the plurality of rotation sensors 74 are positioned within the knob 38 adjacent the second end 34 of the lever 30. The rotation sensors 74 are radially disposed about the lever 30 along the axis A. Usually, the shifter assembly 20 includes a lever sensor 76 fixed to the lever 30 at the second end 34. The lever sensor 76 detects the one of the plurality of rotation sensors 74 which is adjacent to the lever sensor 76. Typically, plurality of rotation sensors 74 is further defined as a pair of rotation sensors 74 with one of the pair of rotation sensors 74 detecting the when the knob 38 is in the first position and the other of the pair of rotation sensors 74 detecting when the knob 38 is in the second position. In the first position the one of the pair of rotation sensors 74 signals to the blocking members 68 to transition into the first state. In the second position the other one of the pair of rotation sensors 74 signals to the blocking members 68 transition to the second state. It is to be appreciated that the plurality of rotation sensors 74 may be any number of rotation sensors 74 and positioned in any configuration for detecting the first and second positions of the knob 38.

Usually, the knob 38 rotates about the axis A between the first and second positions which are separated by less than 90 degrees of rotation. It is to be appreciated that the knob 38 may rotate about the axis A between the first and second positions by any degrees of rotation.

The knob 38 may include a retention device 78, shown in FIG. 4, which prevents inadvertent rotation of the knob 38. Usually, the retention device 78 includes a pair of rings 80 which each ring having a plurality of protrusions 82 radially disposed about the lever 30. The protrusions 82 face the protrusions 82 on the opposing ring. One of the rings 80 is fixed to the knob 38 and the other one of the rings 80 is movable along the axis A and coupled to the lever 30. The movable ring is biased into engagement with the fixed ring. When the protrusions 82 are positioned between the protrusions 82 of the opposing ring, the knob 38 is semi-retained from rotating. To rotate the knob 38, a user must apply a requisite amount of torque to move the fixed ring along the movable ring with the opposing protrusions 82 moving along one another and causing the movable ring to move away from the fixed ring against the bias exerted against the movable ring.

The invention further provides for a method of selecting the one of the plurality of gears of the transmission for the vehicle using the shifter assembly 20, shown in FIGS. 1 and 2, which includes the housing 22 defining the shift pattern 24. The shift pattern 24 has a gate 26, 28 defining at least one shift position. It is to be appreciated that the gate 26, 28 and the at least one shift position may refer to either of the first and second gates 26, 28 and either of the first and second shift positions. For exemplary purposes, the gate 26, 28 will be described below using the second gate 28 as illustration. The shifter assembly 20 further includes the lever 30 extending through the shift pattern 24, the blocking system 36 mounted to the housing 22 as shown in FIGS. 3 and 5-9, and the knob 38 coupled to the lever 30 and in communication with the blocking system 36. The method includes the steps of rotating the knob 38 from the first position, shown in FIGS. 3 and 5-7, to the second position, shown in FIGS. 8 and 9, and transitioning the blocking system 36 from the first state to the second state. It is to be appreciated that the first and second positions and the first and second states are interchangeable. Said differently, the knob 38 may be rotated from the second position to the first position and the blocking system 36 may be transitioned from the second state to the first state. The method further includes the steps of opening the gate 26, 28 with the blocking system 36 and moving the lever 30 to the at least one shift position within the gate 26, 28, as shown in FIGS. 8 and 9. The steps described above are usually performed sequentially; however, it is to be appreciated that the steps may be performed in any suitable order.

The step of moving the lever 30 may further defined as pivoting the lever 30 to the at least one shift position within the gate 26, 28, as illustrated by FIGS. 10 and 11. As described above, the pivoting of the lever 30 may be facilitated by the ball and socket configuration described above or any other suitable configuration.

The method may further include the step of the communicating the second position with the blocking system 36 prior to the step of transitioning the blocking system 36. As described above, the communicating the second position with the blocking system 36 may be performed by the rotation sensors 74 described above.

The lever 30 may have the rest position and the activated position as described above, with the activated position corresponding with the at least one shift position. The method may further include the step of moving the lever 30 to the rest position from the activated position following the step of moving the lever 30 to the at least one shift position. As described above, moving the lever 30 to the rest position may be facilitated by the biasing mechanism 52 in communication with the lever 30. As such, the method may further include the step of biasing the lever 30 toward the rest position prior to the step of moving the lever 30 to the rest position.

The invention has been described in an illustrative manner, and it is to be understood that the terminology which has been used is intended to be in the nature of words of description rather than of limitation. As is now apparent to those skilled in the art, many modifications and variations of the subject invention are possible in light of the above teachings. It is, therefore, to be understood that within the scope of the appended claims, wherein reference numerals are merely for convenience and are not to be in any way limiting, the invention may be practiced otherwise than as specifically described.

1. A shifter assembly for selecting one of a plurality of gears of a transmission for a vehicle, said assembly comprising:
a housing defining a shift pattern having a first gate defining at least one first shift position and a second gate defining at least one second shift position;
a lever extending through said shift pattern along an axis between a first end and a second end and coupled to said housing with said lever selectively movable between said first and second gates and selectively movable into and out of said first and second shift positions within each of said first and second gates;
a blocking system mounted to said housing and transitionable between a first state and a second state with said blocking system opening said first gate to permit movement of said lever within said first gate to said first shift position and simultaneously closing at least a portion of said second gate to restrict movement of said lever into said second shift position when in said first state, and said blocking system opening said second gate to permit movement of said lever within said second gate to said second shift position and simultaneously closing at least a portion of said first gate to restrict movement of said lever into said first shift position when in said second state;
a knob coupled to said second end of said lever and rotatable about said axis between a first position and a second position with said knob in communication with said blocking system to cause said transition of said blocking system between said first state when in said first position and said second state when in said second position.

2. The shifter assembly as set forth in claim 1 wherein said lever has a rest position and an activated position, and further including a biasing mechanism in communication with said lever to continuously bias said lever to said rest position.

3. The shifter assembly as set forth in claim 2 wherein said biasing mechanism includes a plunger slidably disposed within said lever, a biasing member abutting each of said lever and said plunger to continuously bias said plunger away from said lever, and a detent track disposed within and coupled to said housing defining said rest position with said biasing member biasing said plunger into engagement with said detent track.

4. The shifter assembly as set forth in claim 2 wherein said lever extends through said second gate spaced from said second shift position of said second gate when in said rest position.

5. The shifter assembly as set forth in claim 1 wherein said blocking system is further defined as at least two blocking members with one of said at least two blocking members opening said first gate in said first state to permit movement of said lever within said first gate to said first shift position and closing at least a portion of said first gate in said second state to restrict movement of said lever into said first shift position, and another one of said at least two blocking members closing at least a portion of said second gate in said first state to restrict movement of said lever into said second shift position and opening said second gate in said second state to permit movement of said lever within said second gate to said second shift position.

6. The shifter assembly as set forth in claim 5 wherein each of said at least two blocking members includes a solenoid and a plunger with said solenoid capable of moving said plunger for selectively closing said respective gate.

7. The shifter assembly as set forth in claim 1 wherein said shift pattern has an intermediate gate between said first and second gates with said intermediate gate interconnecting said first and second gates to facilitate movement of said lever between said first and second gates to each of said first and second shift positions.

8. The shifter assembly as set forth in claim 7 wherein said first and second gates are substantially parallel with said intermediate gate transverse to each of said first and second gates.

9. The shifter assembly as set forth in claim 2 wherein said activated position is further defined as a plurality of activated positions with one of said activated positions corresponding to said first shift position and another one of said activated positions corresponding with said second shift position.

10. The shifter assembly as set forth in claim 9 further including a first sensor coupled to said housing and associated with said first shift position to detect when said lever is in one of said activated positions that corresponds with said first shift position, and a second sensor coupled to said housing and associated with said second shift position to detect when said lever is in another of said activated positions that corresponds with said second shift position.

11. The shifter assembly as set forth in claim 9 wherein said lever is capable of pivoting relative to said housing to selectively move said lever between said rest position and said activated positions.

12. The shifter assembly as set forth in claim 1 wherein said at least one first shift position is further defined as three first shift positions and said at least one second shift position is further defined as two second shift positions.

13. The shifter assembly as set forth in claim 1 further including a plurality of rotation sensors with one of said rotation sensors detecting when said knob is in said first position to transition said blocking system to said first state and another one of said rotation sensors detecting when said knob is in said second position to transition said blocking system to said second state.

14. A method of selecting one of a plurality of gears of a transmission for a vehicle using a shifter assembly which includes a housing defining a shift pattern having a first gate defining at least one first shift position and a second gate defining at least one second shift position, with-a lever extending through the shift pattern, a blocking system mounted to the housing, and a knob coupled to the lever and in communication with the blocking system, said method comprising the steps of:
rotating the knob from a first position to a second position;
transitioning the blocking system from a first state to a second state when the knob is in the second position;
simultaneously opening the second gate and closing at least a portion of the first gate with the blocking system when the knob is in the second position;
moving the lever to the at least one second shift position within the second gate;
rotating the knob from the second position to the first position:
transitioning the blocking system from the second state to the first state when the knob is in the first position;
simultaneously opening the first gate and closing at least a portion of the second gate with the blocking system when the knob is in the first position; and
moving the lever to the at least one first shift position within the first gate.

15. The method as set forth in claim 14 wherein the steps of moving the lever are further defined as pivoting the lever to the-at-least one shift position-within the gate.

16. The method as set forth in claim 14 further including the step of the communicating the second position with the blocking system prior to the step of transitioning the blocking system.

17. The method as set forth in claim 14 wherein the lever has a rest position and an activated position corresponding with the at least second one shift position and further including the step of moving the lever to the rest position from the activated position following the step of moving the lever to the at least one second shift position.

18. The method as set forth in claim 17 further including a biasing mechanism in communication with the lever and further including the step of biasing the lever toward the rest position prior to the step of moving the lever to the rest position.

19. The method as set forth in claim 14 wherein said lever extends along an axis between a first end and a second end, and wherein the steps of rotating the knob are further defined as rotating the knob about the axis.
